(19) United States
(12) Patent Application Publication
(10) Pub. No.: US 2026/0321650 A1
(43) Pub. Date: Oct. 15, 2026

(54) BINDER COMPOSITION FOR ANODE, ANODE SLURRY COMPOSITION AND SECONDARY BATTERY

(71) Applicant: KOREA KUMHO PETROCHEMICAL CO., LTD., Seoul (KR)

(72) Inventors: June PARK, Seoul (KR); Bo Na CHOI, Seoul (KR); Won Yeong RYU, Seoul (KR); Se Hee JUNG, Seoul (KR)

(73) Assignee: KOREA KUMHO PETROCHEMICAL CO., LTD., Seoul (KR)

(21) Appl. No.: 19/363,954

(22) Filed: Oct. 21, 2025

(30) Foreign Application Priority Data
Oct. 22, 2024 (KR) 10-2024-0144686

(51) Int. Cl. H01M 4/62; H01M 4/02; H01M 4/04; H01M 4/134; H01M 4/38

(52) U.S. Cl. CPC H01M 4/622; H01M 4/0404; H01M 4/134; H01M 4/386; H01M 4/625; H01M 2004/027

(57) ABSTRACT

A binder composition for a negative electrode comprising a block copolymer comprising structural units derived from an aromatic vinyl monomer and a conjugated diene monomer, and water, wherein the block copolymer is dispersed in the water in a liquid colloidal state; a negative electrode slurry composition including the same; and a secondary battery prepared using the same are disclosed.

### CROSS-REFERENCE TO RELATED APPLICATION

This application claims priority to and the benefit of Korean Patent Application No. 10-2024-0144686, filed on Oct. 22, 2024, the disclosure of which is incorporated herein by reference in its entirety.

### FIELD OF THE INVENTION

The present disclosure relates to a binder for use in a negative electrode of a secondary battery and a negative electrode slurry composition.

This study was conducted with the support of research funds from the Ministry of Trade, Industry & Energy and the Korea Evaluation Institute of Industrial Technology (KEIT) in 2024 (‘00404166’).

This work was supported by the Technology Innovation Program (00404166, Development of thin-film coating current collector and aqueous binder to enhance the adhesion and conductivity properties on the silicon-rich anode) funded By the Ministry of Trade, Industry & Energy (MOTIE, Korea)

### BACKGROUND OF THE INVENTION

A secondary battery refers to a device capable of repeatedly performing charging and discharging, in which chemical energy is converted into electrical energy, and is also called a rechargeable battery. Conventional secondary batteries comprise lead storage batteries, nickel-cadmium batteries (NiCd), nickel-metal hydride batteries (NiMH), and lithium secondary batteries. Compared with primary batteries that are used once and discarded, secondary batteries have economic and environmental advantages.

With the development of portable electronic devices centered on smartphones and electric vehicles, industrial demand for batteries having high energy density and stability is increasing, and accordingly, research and development on secondary batteries has been actively conducted in recent years. In particular, as various types of electric vehicles have been commercialized, it has become important to develop secondary batteries capable of reducing manufacturing cost and weight and of extending lifespan. Efforts have been made to improve lithium secondary batteries, which are light, have high energy density and operating potential, and exhibit long cycle life.

One such effort is replacing carbon-based compounds used as negative electrode active materials with silicon-based compounds having high capacity.

Carbon-based compounds have a theoretical capacity of only 372 mAh/g, whereas silicon-based compounds are known to have a theoretical capacity of about 4,200 mAh/g, which is more than ten times higher.

However, silicon-based compounds have a problem in that a volume change of three times or more occurs due to reaction with lithium. In charging and discharging of a secondary battery, electrons must be transferred through a current collector, but repeated volume changes may damage the active material or cause it to detach from the current collector, making electrochemical reactions impossible.

Conventionally, styrene-butadiene rubber binders have been used to bind the negative electrode active material to the current collector. However, such binders easily lose elasticity under repeated volume changes, resulting in insufficient lifespan characteristics.

### DISCLOSURE OF THE INVENTION

### Problem to be Solved

The descriptions of the present disclosure were devised in consideration of the above-described problems of the related art, and an object is to provide a negative electrode binder composition capable of imparting excellent lifespan characteristics to a secondary battery by maintaining elasticity even under repeated volume changes.

Another aspect of the present disclosure has an object of providing a secondary battery having low weight and long lifespan, through a negative electrode slurry composition using the negative electrode binder composition described above.

### Means for Solving the Problem

According to an aspect, a negative electrode binder composition is provided, comprising: a block copolymer comprising structural units derived from an aromatic vinyl monomer and a conjugated diene monomer; and water; wherein the block copolymer is in a liquid colloidal state dispersed in the water.

In an embodiment, the aromatic vinyl monomer may comprise at least one selected from the group consisting of styrene, α-methylstyrene, vinyltoluene, t-butylstyrene, halogen-substituted styrene, 1,3-dimethylstyrene, 2,4-dimethylstyrene, and ethylstyrene.

In addition, the content of the structural unit derived from the aromatic vinyl monomer may be 15 to 45 parts by weight based on 100 parts by weight of the block copolymer.

Meanwhile, the conjugated diene monomer may comprise at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo-1,3-hexadiene.

Here, the weight-average molecular weight of the block copolymer may be 50,000 to 150,000 g/mol.

In an example, at least a portion of the polymer chains of the block copolymer may be modified with at least one selected from a compound comprising silicon, a compound comprising nitrogen, a compound comprising sulfur, and a compound comprising oxygen.

Meanwhile, the negative electrode binder composition may further comprise an emulsifier.

Here, the negative electrode binder composition may further comprise a (meth)acrylate-based polymer, and the weight ratio of the emulsifier to the (meth)acrylate-based polymer may be 1:2.5 to 10.

In addition, the negative electrode binder composition may comprise less than 1 wt % of an organic solvent.

Here, the block copolymer may be dispersed in the water in the form of particles having an average particle size of 50 to 1,000 nm.

According to another aspect, a negative electrode slurry composition is provided, comprising the negative electrode binder composition described above and a negative electrode active material comprising a silicon-based compound.

In an embodiment, the negative electrode active material may further comprise at least one selected from the group consisting of crystalline artificial graphite, crystalline natural graphite, amorphous hard carbon, low-crystallinity soft carbon, carbon black, acetylene black, Ketjen black, graphitized carbon fiber, aluminum, tin, lead, zinc, bismuth, indium, magnesium, gallium, cadmium, tin alloy, aluminum alloy, vanadium oxide, lithium vanadium oxide, silicon-carbon composite, and tin-carbon composite.

Here, the content of the silicon-based compound may be 5 parts by weight or more based on 100 parts by weight of the negative electrode active material.

In addition, the negative electrode slurry composition may further comprise at least one conductive agent selected from the group consisting of natural graphite, artificial graphite, acetylene black, Ketjen black, furnace black, lamp black, thermal black, carbon nanotubes, carbon fiber, graphene, copper, aluminum, nickel, gold, silver, and conductive polymer.

According to another aspect, a secondary battery is provided, comprising a positive electrode, a negative electrode, a separator interposed between the positive electrode and the negative electrode, and an electrolyte; or a solid-state battery comprising a positive electrode, a negative electrode, and a solid electrolyte membrane interposed therebetween; wherein the negative electrode is manufactured by coating the negative electrode slurry composition described above on a current collector and then drying the same.

### Effects of the Invention

The negative electrode binder composition according to an aspect may exhibit excellent recoverable elasticity while maintaining sufficient adhesive strength as a negative electrode binder, and therefore may be applicable to a negative electrode active material comprising a high content of a silicon-based compound.

The effects of an aspect of the present disclosure are not limited to the effects described above, and should be understood to include all effects that can be inferred from the configurations described in the detailed description or the claims of the present disclosure.

### BRIEF DESCRIPTION OF THE DRAWINGS

FIG. 1 illustrates a conceptual diagram of molecular design regarding the adhesive characteristics exhibited by a block copolymer in an example of the present disclosure;

FIG. 2 illustrates an example of a latex form in which the block copolymer is emulsified in water by a phase-inversion emulsification method according to an example of the present disclosure;

FIG. 3 is a graph showing the results of testing the cycle characteristics of a secondary battery according to an embodiment of the present disclosure.

### DETAILED DESCRIPTION FOR CARRYING OUT THE INVENTION

Hereinafter, one aspect of the present specification will be described with reference to the accompanying drawings. However, the matters described in the present specification may be embodied in various different forms, and thus are not limited to the embodiments described herein. In addition, in the drawings, portions not related to the description have been omitted in order to clearly explain one aspect of the present specification, and throughout the specification, similar reference numerals are assigned to similar parts.

Throughout this disclosure, when it is said that a certain part is “connected” to another part, this means that the certain part is not only “directly connected” to the other part but also “indirectly connected” to the other part through another member interposed between the two parts. Also, when it is said that a certain part “includes” a certain element, this means that the certain part may further include, instead of excluding, another element unless particularly indicated otherwise.

When a numerical value is presented in this disclosure, the value has the precision of significant digits provided in accordance with the standard rules in chemistry for significant digits unless its specific range is stated otherwise. For example, the numerical value 10 includes the range of 5.0 to 14.9 and the numerical value 10.0 includes the range of 9.50 to 10.49.

As used herein, the term “structural unit” refers to a repeating structure derived from a specific monomer in a polymer chain. For example, a structural unit derived from 1,3-butadiene may include a trans-1,4 structure, a cis-1,4 structure, a vinyl-1,2 structure, and the like.

As used herein, the term “block” refers to a region in which monomer-derived structural units are arranged in a specific order in a copolymer formed by polymerization of two or more monomers. For example, in a copolymer including structural units A and B, block A may be represented by “A-A-A-A- . . . ” or “ . . . -A-A-A-A- . . . ,” and block B may be represented by “B-B-B-B- . . . ” or “ . . . -B-B-B-B- . . . ”.

Hereinafter, an aspect of the present disclosure will be described in detail with reference to the accompanying drawings.

### Binder Composition for Negative Electrode

The binder composition for a negative electrode according to an aspect comprises a block copolymer comprising structural units derived from an aromatic vinyl monomer and a conjugated diene monomer; and water; and the block copolymer may be in a liquid colloidal state dispersed in the water.

A secondary battery is a device capable of storing and using energy multiple times through charging and discharging, which is a process of converting electrical energy and chemical energy. A lithium secondary battery mediates the conversion between electrical energy and chemical energy by utilizing the movement of lithium ions and electrons.

In a secondary battery, the negative electrode is an electrode in which reduction of lithium ions occurs during charging, and oxidation of lithium ions occurs during discharging. Here, lithium ions are stored and released through interaction with the negative electrode active material.

Conventionally, carbon-based materials such as graphite have mainly been used as negative electrode active materials. However, graphite has a theoretical specific capacity of only 372 mAh/g. Accordingly, attempts have been made to replace it with silicon-based compounds having theoretical specific capacities of 4,000 mAh/g or more.

However, silicon-based compounds undergo large volume changes due to reactions with lithium ions during charging and discharging. Therefore, when silicon-based compounds are used in large amounts, stresses may be generated, causing fracture of the active material or separation between components in the negative electrode.

Attempts have been made to overcome these limitations by using styrene-butadiene rubber, having elasticity, as a binder for the negative electrode. However, even when using this binder, when the content of silicon-based compounds in the negative electrode active material exceeds 3 wt %, the capacity decreases during multiple cycles due to the limitations of the material.

In contrast, the binder composition for a negative electrode according to an aspect of the present disclosure can exhibit high capacity retention even when applying 5 wt % or more of a silicon-based compound, because a block copolymer having high elasticity, high strength, and excellent recoverable elasticity is used.

The block copolymer may connect each component constituting the negative electrode, such as the active material, conductive agent, and current collector. In addition, since the block copolymer has elasticity, it may tightly adhere each component to prevent separation due to volume changes.

The block copolymer comprises a structural unit derived from an aromatic vinyl monomer and a structural unit derived from a conjugated diene monomer. The inclusion of a structural unit derived from a monomer means that the polymer or copolymer is prepared by polymerizing the monomer. In such a polymer or copolymer, each monomer exists as one or more repeating structures forming a polymer chain. These repeating structures are referred to as structural units, and one monomer may exist in several forms of a structural unit.

The aromatic vinyl monomer refers to a monomer comprising an aromatic ring structure, which has a conjugated π-electron system, and a vinyl structure having a carbon-carbon double bond. For example, the aromatic vinyl monomer may comprise at least one selected from the group consisting of styrene, α-methylstyrene, vinyltoluene, t-butylstyrene, halogen-substituted styrene, 1,3-dimethylstyrene, 2,4-dimethylstyrene, and ethylstyrene, but is not limited thereto. The structural unit derived from the aromatic vinyl monomer may form a hard-segment block of the copolymer.

The content of the structural unit derived from the aromatic vinyl monomer may be 15 to 45 parts by weight based on 100 parts by weight of the block copolymer, for example, 15 parts by weight, 17.5 parts by weight, 20 parts by weight, 22.5 parts by weight, 25 parts by weight, 27.5 parts by weight, 30 parts by weight, 32.5 parts by weight, 35 parts by weight, 37.5 parts by weight, 40 parts by weight, 42.5 parts by weight, 45 parts by weight, or a range between any two of these values. When the content satisfies this range, the binder may have balanced properties such as usability and adhesion. In addition, the block copolymer may be well dispersed in water.

The structural unit derived from the aromatic vinyl monomer may impart adhesive strength to the binder through physical crosslinking. When the content increases, the polymer chain may become relatively rigid and exhibit increased cohesive strength in specific regions, thereby improving mechanical properties such as adhesion and hardness. However, if the content becomes excessively high, flexibility of the polymer chain may be excessively reduced and the properties may deteriorate. Conversely, if the content is insufficient, viscosity may become too high or adhesion may be insufficient.

The conjugated diene monomer refers to a hydrocarbon-based compound comprising a structure in which two carbon-carbon double bonds are directly connected through a carbon-carbon single bond. For example, it may comprise at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo-1,3-hexadiene, but is not limited thereto. The structural unit derived from the conjugated diene monomer may form a soft-segment block of the copolymer.

The structural unit derived from a conjugated diene monomer may exist in one or more forms. For example, the structural unit derived from 1,3-butadiene may exist as cis-1,4 structures, trans-1,4 structures, or vinyl-1,2 structures in the polymer chain. In the copolymer, the cis-1,4 structure may have high crystallinity and a low glass transition temperature (T_{g}). The trans-1,4 structure may have relatively low crystallinity. The vinyl-1,2 structure may have a high T_{g}.

The structural unit derived from a conjugated diene monomer may impart excellent mechanical properties to the binder. In addition, they may impart elasticity to the copolymer. When the block copolymer used as a binder has elasticity, capacity loss due to volume changes in the negative electrode may be prevented.

The weight-average molecular weight of the block copolymer may be 50,000 to 150,000 g/mol, for example, 50,000 g/mol, 52,500 g/mol, 55,000 g/mol, 57,500 g/mol, 60,000 g/mol, 62,500 g/mol, 65,000 g/mol, 67,500 g/mol, 70,000 g/mol, 72,500 g/mol, 75,000 g/mol, 77,500 g/mol, 80,000 g/mol, 82,500 g/mol, 85,000 g/mol, 87,500 g/mol, 90,000 g/mol, 92,500 g/mol, 95,000 g/mol, 97,500 g/mol, 100,000 g/mol, 102,500 g/mol, 105,000 g/mol, 107,500 g/mol, 110,000 g/mol, 112,500 g/mol, 115,000 g/mol, 117,500 g/mol, 120,000 g/mol, 122,500 g/mol, 125,000 g/mol, 127,500 g/mol, 130,000 g/mol, 132,500 g/mol, 135,000 g/mol, 137,500 g/mol, 140,000 g/mol, 142,500 g/mol, 145,000 g/mol, 147,500 g/mol, 150,000 g/mol, or a range between these two values, but is not limited thereto.

This weight-average molecular weight may be checked using various measurement methods depending on the type of polymer. For example, gel permeation chromatography using polystyrene standard conversion may be used, but is not limited thereto.

In an example, the block copolymer may be a linear copolymer or a branched copolymer in which two or more linear copolymer arms having the above-described weight-average molecular weight are coupled. When such copolymers are used as a binder, the polymer may contact an adherend in a dissociated state, maintain adhesion even when components of the negative electrode are separated due to volume change, and reduce the distance between components due to recoverable elasticity, forming a linear network.

In an example, when the block copolymer comprises a branched copolymer in which two or more arms having the above-described molecular weight are coupled, the molecular-weight measurement result may simultaneously show a linear copolymer within the above-described range and branched copolymers having molecular weight close to an integer multiple (e.g., 2 times, 3 times, 4 times, 5 times, 6 times, 7 times, 8 times, 9 times, 10 times, etc.) of the molecular weight of the linear copolymer

When the molecular weight of the block copolymer or its arms deviates from the above range, the negative electrode slurry containing the binder composition may not be well coated on the current collector, or the block copolymer may not exist as a liquid colloidal state dispersed in water.

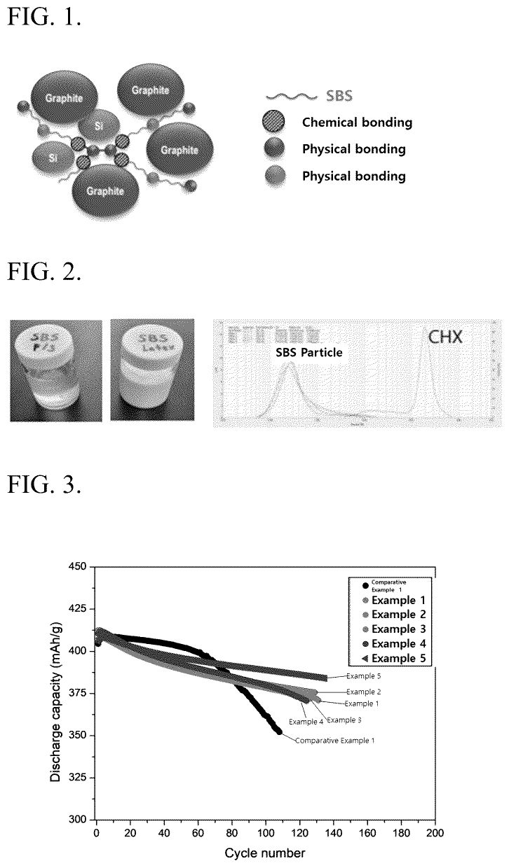

FIG. 1 illustrates an exemplary conceptual diagram of molecular design for the block copolymer according to the present disclosure.

For example, the block copolymer may be bonded by linear contact of dissociated block copolymers with at least a portion of a surface of an adherend. Herein, the bonding may be achieved in various forms, such as hydrogen bonding, van der Waals bonding, and covalent bonding.

In an example, at least a portion of the polymer chains of the block copolymer may be modified with at least one selected from a compound comprising silicon, a compound comprising nitrogen, a compound comprising sulfur, and a compound comprising oxygen.

Herein, the compound comprising silicon, the compound comprising nitrogen, the compound comprising sulfur, and the compound comprising oxygen are referred to as “modifying compounds.”

The modifying compound may comprise at least one selected from silicon, nitrogen, sulfur, and oxygen. For example, it may comprise both silicon and nitrogen, or both sulfur and oxygen. In other examples, it may comprise an amino structure, imino structure, mercapto structure, thiol structure, glycidoxy structure, epoxy structure, isocyanate structure, alkoxysilane structure, and the like, but is not limited thereto.

The modifying compound may be introduced at least at one terminal of the polymer chain of the block copolymer or into an internal position of the chain. When the modifying compound is introduced at the terminal of the polymer chain, it may be obtained by reacting a living polymer having residual reactivity during polymerization with a modifying compound. When introduced into an internal region of the polymer chain, it may be obtained by directly or indirectly reacting the modifying compound with the double bonds present in the structural unit derived from the conjugated diene monomer. The reaction of the double bond may use a radical reaction employing a photoinitiator, a thermal initiator, and the like.

For example, the modifying compound may comprise at least one selected from the group consisting of hydrogen peroxide, epichlorohydrin, mercaptopropionic acid, mercaptohexanoic acid, mercaptobenzoic acid, 1-(trimethoxysilyl)methanamine, 1-(triethoxysilyl)methanamine, 2-(trimethoxysilyl)ethanamine, 2-(triethoxysilyl)ethanamine, 3-aminopropyltrimethoxysilane, 3-aminopropyltriethoxysilane, 4-aminobutyltrimethoxysilane, 4-aminobutyltriethoxysilane, 3-aminopropylmethyldimethoxysilane, 3-aminopropylmethyldiethoxysilane, 3-aminopropylethyldimethoxysilane, 3-aminopropylethyldiethoxysilane, 3-aminopropyldimethylmethoxysilane, 3-aminopropyldimethylethoxysilane, 3-aminopropyldiethylmethoxysilane, 3-aminopropyldiethylethoxysilane, N-(2-aminoethyl)-3-aminopropylmethyldimethoxysilane, N-2-(aminoethyl)-3-aminopropylmethyldimethoxysilane, N-2-(aminoethyl)-3-aminopropyltrimethoxysilane, N-(3-(trimethoxysilyl)propyl)butylamine, diethylenetriaminopropyltrimethoxysilane, diethylaminomethyltriethoxysilane, N-phenyl-3-aminopropyltrimethoxysilane, (N-phenylamino)methyltriethoxysilane, N-(3-aminopropyl)cyclohexylamine, 1-(trimethoxysilyl)methanethiol, 1-(triethoxysilyl)methanethiol, 2-(trimethoxysilyl)ethanethiol, 2-(triethoxysilyl)ethanethiol, 3-mercaptopropyltrimethoxysilane, 3-mercaptopropyltriethoxysilane, 4-mercaptobutyltrimethoxysilane, 4-mercaptobutyltriethoxysilane, 3-mercaptopropylmethyldimethoxysilane, 3-mercaptopropylmethyldiethoxysilane, 3-mercaptopropylethyldimethoxysilane, 3-mercaptopropylethyldiethoxysilane, 3-mercaptopropyldimethylmethoxysilane, 3-mercaptopropyldimethylethoxysilane, 3-mercaptopropyldiethylmethoxysilane, 3-mercaptopropyldiethylethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, and 3-(1,3-dimethylbutylidene)aminopropyltriethoxysilane, but is not limited thereto.

The content of the modifying compound introduced based on 100 parts by weight of the block copolymer may be 0.5 to 10 parts by weight, for example 0.5 parts by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weight, or a range between any two of these values, but is not limited thereto.

When emulsion polymerization using water as a solvent for the monomers is applied, a block copolymer dispersed in water may be prepared. However, when applying emulsion polymerization, it may be difficult to prepare a modified copolymer, or the degree of modification may be insufficient.

In an example, the block copolymer may be a copolymer in which each monomer is polymerized by anionic polymerization in an organic solvent. In anionic polymerization, after mixing the monomers in the solvent, an anionic initiator is introduced to initiate the polymerization. Thereafter, the initiator sequentially bonds with the monomers to grow the polymer, and the reaction may be terminated by adding a polymerization terminator. By varying the catalyst system used here, the microstructure of the polymer may be controlled to adjust the polymer properties. In anionic polymerization, the active ends of polymers tend to repel each other, and therefore bimolecular termination is less likely to occur and chain transfer is minimal, making it known to be most suitable for living polymerization. Owing to these characteristics, polymers prepared by anionic polymerization may be easily modified.

However, a block copolymer prepared by anionic polymerization is typically in a state dissolved or dispersed in an organic solvent, or in a state of solid rubber obtained by removing the organic solvent through a stripping process.

Herein, examples of an organic solvent in which the polymer may be dissolved or dispersed include at least one selected from the group consisting of n-pentane, iso-pentane, n-hexane, n-heptane, iso-heptane, n-octane, iso-octane, cyclohexane, methylcyclopentane, benzene, toluene, xylene, and ethylbenzene, but are not limited thereto.

When the polymer is dissolved in an organic solvent, the polymer chains may exist in a dissociated, non-entangled state. On the other hand, in a polymer solution in which the polymer is dispersed in the organic solvent, polymer chains may be entangled to form discontinuous-phase particles that exist in the continuous phase of the organic solvent. Such polymers generally have low affinity for water, and therefore are known to be difficult to disperse in water.

Meanwhile, the binder composition for a negative electrode may further comprise an emulsifier. Using an emulsifier, the polymer may be emulsified in water by mixing organic and inorganic phases using an emulsifier or a disperser. Here, the emulsifier may be added to at least one of the polymer solution or the water, or may be added during mixing of the two. As a result, the polymer may become unstable and undergo phase inversion in which it becomes dispersed in water. Here, addition and mixing may be performed by spraying one phase into the other under high pressure, but are not limited thereto.

FIG. 2 illustrates an example in which a block copolymer is emulsified in water by a phase-inversion emulsification method according to an example of the present disclosure.

As a non-limiting example, the emulsifier may be at least one selected from the group consisting of an anionic surfactant, a nonionic surfactant, a cationic surfactant, and an amphoteric surfactant. For example, the emulsifier may be at least one selected from the group consisting of sodium laurate, potassium laurate, sodium tetradecanoate, potassium tetradecanoate, sodium hexadecanoate, potassium hexadecanoate, sodium oleate, potassium oleate, sodium linolenate, potassium linolenate, rosin soap, sodium rosinate, potassium rosinate, sodium dodecylbenzenesulfonate, potassium dodecylbenzenesulfonate, sodium decylbenzenesulfonate, potassium decylbenzenesulfonate, sodium cetylbenzenesulfonate, potassium cetylbenzenesulfonate, sodium di(2-ethylhexyl)sulfosuccinate, potassium di(2-ethylhexyl)sulfosuccinate, sodium dioctylsulfosuccinate, alkyl sulfosuccinates; sodium lauryl sulfate, potassium lauryl sulfate, sodium polyoxyethylene lauryl ether sulfate, potassium polyoxyethylene lauryl ether sulfate, sodium lauryl phosphate, and potassium lauryl phosphate, but are not limited thereto.

When the hydrophilic-lipophilic balance (HLB) value of the emulsifier is small, the viscosity of the polymer emulsion may become higher and the average particle size may become smaller. For example, the HLB value of the emulsifier may be 8 to 18, but is not limited thereto.

Here, the binder composition for a negative electrode may further comprise a (meth)acrylate-based polymer. The (meth)acrylate-based polymer may refer to a polymer prepared by polymerizing a compound comprising an acryl group and/or methacryl group as a monomer.

For example, the (meth)acrylate-based polymer may comprise a structural unit derived from at least one selected from the group consisting of acrylic acid, methacrylic acid, methyl acrylate, methyl methacrylate, butyl acrylate, itaconic acid, crotonic acid, fumaric acid, and maleic acid, but is not limited thereto.

When the emulsifier further comprises a (meth)acrylate-based polymer, the phase-inversion of the block copolymer may be induced more easily.

The weight ratio of the emulsifier to the (meth)acrylate-based polymer may be 1:2.5 to 10, for example 1:2.5, 1:3, 1:3.5, 1:4, 1:4.5, 1:5, 1:5.5, 1:6, 1:6.5, 1:7, 1:7.5, 1:8, 1:8.5, 1:9, 1:9.5, 1:10, or a range between any two of these values, but is not limited thereto.

Meanwhile, the total content of the emulsifier or the emulsifier and the (meth)acrylate-based polymer combined may be 0.1 to 50 parts by weight based on 100 parts by weight of the block copolymer, for example 0.1 part by weight, 1 part by weight, 2.5 parts by weight, 5 parts by weight, 7.5 parts by weight, 10 parts by weight, 12.5 parts by weight, 15 parts by weight, 17.5 parts by weight, 20 parts by weight, 22.5 parts by weight, 25 parts by weight, 27.5 parts by weight, 30 parts by weight, 32.5 parts by weight, 35 parts by weight, 37.5 parts by weight, 40 parts by weight, 42.5 parts by weight, 45 parts by weight, 47.5 parts by weight, 50 parts by weight, or a range between any two of these values, based on 100 parts by weight of the block copolymer, but is not limited thereto. If the content thereof is excessively high, the binder function may be impaired. Meanwhile, by adjusting the content of the above component, unnecessary aggregation of the copolymer can be minimized, thereby allowing the average particle size to be controlled within a desired range.

Meanwhile, the binder composition for a negative electrode may comprise less than 1 wt % of an organic solvent. When the block copolymer is dispersed in water using the phase-inversion phenomenon, the organic solvent may be removed through an additional process. The additional process may use typical methods known in the art depending on the type of organic solvent.

Because a negative electrode active material comprising a silicon-based active material, a carbon-based compound, and the like have higher affinity for water than for organic solvents, it is advantageous to apply a water-based binder rather than an organic solvent-based binder. Therefore, the binder composition for a negative electrode may be in a liquid colloidal state in which the block copolymer is dispersed in water.

In this state, the polymer may be dispersed in the continuous water phase as small discontinuous-phase particles surrounded by the emulsifier. During this process, entanglement between polymer chains is minimized, enabling a small average particle size.

Meanwhile, when a high-pressure homogenizer is used to disperse the polymer, a polymer emulsion having relatively small particle size may be prepared. Here, the treatment conditions of the homogenizer are not particularly limited and may be selected such that the desired dispersion state is achieved, considering temperature, time, and pressure.

The polymer may exist in the emulsion in the form of small spherical particles. The small-sized polymer particles may exhibit improved adhesive strength due to larger surface area and better dispersibility when used as a binder. In an example, the polymer may be dispersed in the water in the form of particles having an average particle size of 50 to 1,000 nm, for example, 50 nm, 75 nm, 100 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1,000 nm, or a range between any two of these values, but is not limited thereto.

### Negative Electrode Slurry Composition

A negative electrode slurry composition according to another aspect comprises the binder composition for a negative electrode described above and a negative electrode active material comprising a silicon-based compound.

The negative electrode slurry composition is also referred to as a negative electrode mixture and may be a composition mixed in a form suitable for coating and drying on a current collector.

Here, the content of the block copolymer in the binder composition for a negative electrode may be 0.5 to 10 parts by weight based on 100 parts by weight of the negative electrode active material, for example 0.5 part by weight, 1 part by weight, 1.5 parts by weight, 2 parts by weight, 2.5 parts by weight, 3 parts by weight, 3.5 parts by weight, 4 parts by weight, 4.5 parts by weight, 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weight, or a range between any two of these values.

If the content of the block copolymer acting as a binder is too low, binding force may be insufficient; conversely, if the content is too high, the performance of the negative electrode may deteriorate or slurry coating may become difficult.

The negative electrode active material may comprise a compound capable of reversible intercalation/deintercalation of lithium ions (Li⁺) or sodium ions (Na⁺). The silicon-based compound may allow reversible intercalation/deintercalation of lithium ions.

The silicon-based compound may comprise silicon metal, silicon oxide, silicon carbide, silicon nitride, and the like. The silicon-based compound may be in the form of rod-shaped particles, elliptical particles, spherical particles, or irregularly shaped particles.

In addition to the silicon-based compound, the negative electrode active material may further comprise various compounds, provided that they allow reversible intercalation/deintercalation of lithium ions. For example, the negative electrode active material may further comprise at least one selected from the group consisting of crystalline artificial graphite, crystalline natural graphite, amorphous hard carbon, low-crystallinity soft carbon, carbon black, acetylene black, Ketjen black, graphitized carbon fiber, aluminum, tin, lead, zinc, bismuth, indium, magnesium, gallium, cadmium, tin alloy, aluminum alloy, vanadium oxide, lithium vanadium oxide, silicon-carbon composite, and tin-carbon composite, but is not limited thereto.

Here, the content of the silicon-based compound may be 5 parts by weight or more based on 100 parts by weight of the negative electrode active material, for example 5 parts by weight, 5.5 parts by weight, 6 parts by weight, 6.5 parts by weight, 7 parts by weight, 7.5 parts by weight, 8 parts by weight, 8.5 parts by weight, 9 parts by weight, 9.5 parts by weight, 10 parts by weight or more, or a range between any two of these values.

As the content of the silicon-based compound increases, capacity increases; however, lifespan characteristics may deteriorate due to volume changes. Nonetheless, the binder composition for a negative electrode according to the present disclosure has excellent resistance to volume change compared with conventional binders, and therefore may include a relatively high content of silicon-based compounds.

In addition, the negative electrode slurry composition may further comprise at least one conductive agent selected from the group consisting of natural graphite, artificial graphite, acetylene black, Ketjen black, furnace black, lamp black, thermal black, carbon nanotubes, carbon fiber, graphene, copper, aluminum, nickel, gold, silver, and conductive polymers, but is not limited thereto.

The conductive agent is used to impart electrical conductivity so that electrons may move in conjunction with ion movement, and its type is not limited as long as it has electron conductivity without unnecessary chemical reactions.

Secondary Battery According to another aspect, the secondary battery may be a battery comprising a positive electrode, a negative electrode, a separator interposed therebetween, and an electrolyte, or an all-solid-state battery including a positive electrode, a negative electrode, and a solid electrolyte layer interposed therebetween, wherein the negative electrode may be prepared by coating the above-described negative electrode slurry composition onto a current collector and then drying the same.

The positive electrode and the negative electrode perform the role of storing and releasing energy through electrochemical actions such as intercalation/deintercalation of ions. Meanwhile, the separator is interposed between the positive electrode and the negative electrode and prevents short-circuiting caused by their direct contact. Here, the electrolyte or electrolytic solution mediates the movement of ions and electrons.

Generally, a secondary battery comprises a positive electrode, a negative electrode, a separator, and an electrolyte; however, a separator may be omitted when a solid electrolyte is used as the electrolyte. Here, a film formed of a solid electrolyte, that is, a solid electrolyte layer, is interposed between the positive electrode and the negative electrode to prevent direct contact between the positive electrode and the negative electrode, thereby serving the role of a separator. Such a secondary battery does not comprise any liquid components and is therefore referred to as an all-solid-state battery.

The positive electrode may be obtained, for example, by applying and drying a positive electrode slurry comprising a positive electrode active material such as cobalt oxide-based (LCO), nickel oxide-based (LNO), manganese oxide-based (LMO), nickel-cobalt-manganese oxide-based (NCM), nickel-cobalt-aluminum oxide-based (NCA), iron phosphate-based (LFP), or those doped and/or coated, on a current collector, but is not limited thereto.

Examples of methods for coating the electrode slurry composition include doctor blade coating, die casting, comma coating, and screen printing. In addition, the electrode slurry composition may be molded on a separate substrate and then laminated or pressed to bond it to the current collector. At this time, the coating thickness may be adjusted by controlling the slurry concentration or the number of coating passes.

The drying process refers to a process of removing the solvent and moisture by drying the slurry composition coated on the current collector, and the specific method may vary depending on the solvent used. For example, it may be performed in a vacuum oven at 50 to 200° C. Other examples of drying methods include hot air drying, heated air drying, low-humidity air drying, vacuum drying, and drying by irradiation with far-infrared rays or electron beams. Typically, drying is performed for 30 seconds to 24 hours.

After the drying process, a cooling process may further be included. An example of the cooling process includes slow cooling to room temperature to allow the binder to form a well-developed recrystallized structure.

If necessary, after the drying process, a rolling process may be performed to compress the electrode to a desired thickness, thereby increasing capacity density and improving adhesion between the current collector and the active material. Such a rolling process may be performed by typical methods such as passing the electrode between rotating rolls or using a plate press.

The current collector used in positive electrode fabrication is not particularly limited as long as it is conductive and does not undergo undesirable chemical reactions. Examples include aluminum, nickel, titanium, calcined carbon, and stainless steel. Fine surface roughness may be formed on the surface of the current collector to enhance adhesion with the positive electrode active material, and various forms such as films, sheets, foils, meshes, nets, porous bodies, foamed bodies, and nonwoven fabrics may be used.

The negative electrode may be manufactured by coating and drying the negative electrode slurry composition described above on a current collector. The coating and drying methods described above for the positive electrode may be applied in the same manner.

The current collector used for negative electrode fabrication is also not limited as long as it is conductive and does not undergo undesirable chemical reactions. Examples include copper, aluminum, nickel, titanium, silver, carbon, and stainless steel. Fine surface roughness may be formed on the surface of the current collector to enhance adhesion with the negative electrode active material, and various forms such as films, sheets, foils, meshes, nets, porous bodies, foamed bodies, and nonwoven fabrics may be applied.

The secondary battery may further comprise a container for accommodating the above-described components and a sealing member for sealing the container. Examples of such containers include cylindrical cans, prismatic cans, coin-type cans, and pouches, but are not limited thereto.

Hereinafter, examples of the present disclosure will be described in further detail. However, the following experimental results are obtained from only a few selected examples of the disclosure, and the scope and contents of the present disclosure should not be interpreted as being reduced or limited by the few selected examples. The effects of each of the various embodiments of the present disclosure, which are not explicitly set forth below, will be described in detail in relevant sections.

### Comparative Example 1

An emulsion was prepared of a styrene-butadiene rubber copolymer modified with 5 wt % of a carboxylic acid, which is conventionally used as a binder for a negative electrode.

### Example 1

A 10 L reactor purged with nitrogen was charged with 1,150 parts by weight of cyclohexane, 45 parts by weight of styrene, and 0.0001 parts by weight of ditetrahydrofurylpropane, and the mixture was stirred. After adjusting the reactor temperature to 60° C., 0.3 parts by weight of n-butyllithium was introduced into the reactor to initiate the reaction. After the reactor temperature reached its peak, the reaction was further continued for 10 minutes, and then 65 parts by weight of 1,3-butadiene was introduced. After the reactor temperature again reached its peak, the reaction was continued for an additional 10 minutes, and then triethoxysilylpropyl diethylamine, in an amount of 1.1 mol equivalent per total monomer amount, was introduced to terminate the polymerization. When modification was completed, an antioxidant was added to terminate the reaction, thereby obtaining a polymer solution. The weight-average molecular weight of the polymer was 93,000 g/mol, and the content of the styrene block was confirmed to be 40 wt %.

Based on 100 parts by weight of the polymer in the solution, 1,250 parts by weight of an aqueous solution comprising 5 parts by weight of rosin soap as an emulsifier was prepared. Using a high-pressure homogenizer under conditions of room temperature and a discharge pressure of 300 kg/cm², the polymer solution was introduced into the emulsifier-containing aqueous solution. Thereafter, the mixture was heated to 60° C. and depressurized to remove cyclohexane. The mixture was centrifuged at 7,000 rpm at 25° C. to prepare a styrene-butadiene-styrene block copolymer emulsion having a solid content of 40%.

### Example 2

A polymer solution was prepared in which 100 parts by weight of a styrene-butadiene-styrene copolymer having a weight-average molecular weight of 93,000 g/mol, a styrene content of 40 wt %, and modified at the terminal with triethoxysilylpropyl diethylamine was dissolved in 1,150 parts by weight of cyclohexane.

Based on 100 parts by weight of the polymer in the solution, 1,250 parts by weight of an aqueous solution containing 5 parts by weight of an emulsifier in which polyacrylic acid and rosin soap were mixed at a weight ratio of 1:5 was prepared. Using a high-pressure homogenizer at room temperature and 300 kg/cm² discharge pressure, the polymer solution was introduced into the emulsifier-containing aqueous solution. The mixture was heated to 60° C. and depressurized to remove cyclohexane. Centrifugation at 7,000 rpm at 25° C. yielded a styrene-butadiene-styrene block copolymer emulsion having a 40% solid content.

### Example 3

A polymer solution was prepared in which 100 parts by weight of a styrene-butadiene-styrene copolymer having a weight-average molecular weight of 150,000 g/mol, a styrene content of 40 wt %, and modified at the terminal with triethoxysilylpropyl diethylamine was dissolved in 1,150 parts by weight of cyclohexane.

Based on 100 parts by weight of the polymer in the solution, 1,250 parts by weight of an aqueous solution containing 5 parts by weight of an emulsifier in which polyacrylic acid and rosin soap were mixed at a weight ratio of 1:5 was prepared. Using a high-pressure homogenizer under room temperature and 300 kg/cm² discharge pressure, the polymer solution was introduced into the emulsifier-containing aqueous solution. After heating to 60° C. and depressurizing to remove cyclohexane, centrifugation at 7,000 rpm at 25° C. yielded a styrene-butadiene-styrene block copolymer emulsion having a 40% solid content.

### Example 4

A polymer solution was prepared in which 100 parts by weight of a styrene-butadiene-styrene copolymer having a weight-average molecular weight of 120,000 g/mol, a styrene content of 40 wt %, and modified at the terminal with triethoxysilylpropyl diethylamine was dissolved in 1,150 parts by weight of cyclohexane.

Based on 100 parts by weight of the polymer in the solution, 1,250 parts by weight of an aqueous solution containing 5 parts by weight of an emulsifier in which polyacrylic acid and rosin soap were mixed at a weight ratio of 1:5 was prepared. Using a high-pressure homogenizer at room temperature and 300 kg/cm² discharge pressure, the polymer solution was introduced into the aqueous phase. After heating to 60° C. and removing cyclohexane under reduced pressure, centrifugation at 7,000 rpm at 25° C. yielded a styrene-butadiene-styrene block copolymer emulsion having a 40% solid content.

### Example 5

A benzophenone compound was irradiated with UV light to form radicals. The radicals were reacted with 3-mercaptopropionic acid to form thiyl radicals. A styrene-butadiene-styrene block copolymer having a weight-average molecular weight of 50,000 g/mol and a styrene content of 40 wt % was reacted with 3 mol % of the thiyl radicals (based on total monomer content), thereby preparing a block copolymer solution in which mercaptocarboxyl groups were grafted.

Based on 100 parts by weight of the polymer in the solution, 1,250 parts by weight of an aqueous solution containing 5 parts by weight of an emulsifier in which polyacrylic acid and rosin soap were mixed at a weight ratio of 1:5 was prepared. Using a high-pressure homogenizer at room temperature and 300 kg/cm² discharge pressure, the polymer solution was introduced into the emulsifier-containing aqueous solution. After heating to 60° C. and removing cyclohexane under reduced pressure, centrifugation at 7,000 rpm at 25° C. yielded a styrene-butadiene-styrene block copolymer emulsion having a 40% solid content.

### Experimental Example 1

The average particle size (D₅₀) of polymer particles in the styrene-butadiene-styrene block copolymer emulsions prepared in the Examples and Comparative Example was measured, and the results are shown in Table 1 below.

TABLE 1

| | Comparative | | | | | |
|---|---|---|---|---|---|---|
| Classification | Example 1 | Example 1 | Example 2 | Example 3 | Example 4 | Example 5 |
| Average | 155 | 248 | 265 | 298 | 334 | 282 |
| particle size | | | | | | |
| (nm) | | | | | | |

Referring to Table 1, it can be seen that the block copolymers emulsified by the phase inversion method after solution polymerization in the Examples also have particle sizes close to those of the latex prepared by emulsion polymerization in Comparative Example 1.

That is, according to the Examples, even though a solution polymerization method was employed, which, unlike an emulsion polymerization method, allows easy terminal modification and provides a narrow molecular weight distribution, it is still possible to prepare an emulsion at a latex level.

### Experimental Example 2

A negative electrode slurry was prepared by mixing 95 parts by weight of a negative electrode active material, 1 part by weight of carbon nanotubes, 1.5 parts by weight of carboxymethyl cellulose, and 2.5 parts by weight of each copolymer emulsion of the Comparative Example and the Examples in ion-exchange water, to reach a density of 1.60 g/cc. Here, the negative electrode active material was a mixture of natural graphite and a SiOₓ silicon-based active material in a weight ratio of 95:5.

A negative electrode was manufactured by coating and drying the negative electrode slurry on a copper-foil current collector such that the loading level was 10.0 mg/cm².

The adhesion strength of the electrode plate was evaluated by separating the negative electrode coating layer from the current collector while measuring displacement and force, and the results are shown in Table 2 below.

TABLE 2

| Classi- | | | | | |
|---|---|---|---|---|---|
| fication | Example 1 | Example 2 | Example 3 | Example 4 | Example 5 |
| Average | 0.3 | 6.4 | 5.3 | 5.9 | 3.5 |
| (kgf/mm) | | | | | |
| Maximum | 1.2 | 17.2 | 12.3 | 9.4 | 9.4 |
| (kgf/mm) | | | | | |

Referring to Table 2, it can be confirmed that, as compared with Example 1, in which only rosin soap was used as an emulsifier, the negative electrodes using the emulsions of Examples 2 to 5, which were emulsified using both rosin soap and a polyacrylic acid polymer, exhibit higher adhesion strength.

### Experimental Example 3

The negative electrode of Experimental Example 2, a polyethylene separator, and a 700-μm-thick lithium-metal cathode were assembled, and an electrolyte was injected to manufacture a coin-type cell of 2032 standard. The battery was formed by charging at 0.1 C, 0 V in constant-current/constant-voltage mode and discharging at 0.1 C constant current for two cycles. As the electrolyte, a mixture comprising 1 M LiPF₆ dissolved in a 3:7 mixed solvent of ethylene carbonate and ethyl methyl carbonate, further comprising 5 wt % fluoroethylene carbonate, was used.

Subsequently, battery characteristics were evaluated by repeatedly charging and discharging at 0.5 C at 25° C., and the results are shown in Table 3 and FIG. 3 below.

TABLE 3

| | Comparative | | | | | |
|---|---|---|---|---|---|---|
| Classification | Example 1 | Example 1 | Example 2 | Example 3 | Example 4 | Example 5 |
| 1st-cycle | 407.4 | 406.9 | 411.2 | 408.2 | 408.6 | 406.6 |
| capacity | | | | | | |
| (mAh/g) | | | | | | |
| 100^{th}-cycle | 352.1 | 370.9 | 380.4 | 378.2 | 379.8 | 388.7 |
| capacity | | | | | | |
| (mAh/g) | | | | | | |
| 100^{th}-cycle | 87.0 | 91.1 | 92.2 | 92.9 | 92.5 | 95.7 |
| capacity | | | | | | |
| retention (%) | | | | | | |

Referring to FIG. 3 and Table 3, it can be observed that all samples exhibited capacities higher than the theoretical capacity of graphite (372 mAh/g) at the initial charge-discharge stage; however, the capacities decreased as the number of cycles increased. In particular, Comparative Example 1, which employed a conventional binder for negative electrodes, showed a sharp capacity drop after 80 cycles, whereas such an abrupt decrease was not observed when the binders of the Examples were applied.

Although an unvulcanized styrene-butadiene-styrene block copolymer was used as the binder in the Examples, it is presumed that the physical crosslinking of the styrene block domains and the rubber-like properties of the butadiene block resulted in excellent binder performance. In addition, functional groups introduced at the terminals or within the backbone of the copolymer are believed to improve adhesion to the negative electrode active material, thereby enabling superior capacity retention despite volume changes.

The above description of the present disclosure is provided for illustrative purposes, and those skilled in the art to which an aspect of the present disclosure pertains will understand that various modifications may be made in other specific forms without departing from the technical spirit or essential characteristics described in the present disclosure. Therefore, the embodiments described above should be understood to be illustrative in all respects and not limiting. For example, the components described as being configured in a single form may be implemented in a distributed form, and likewise, components described as being distributed may be implemented in a combined form.

The scope of the present disclosure is defined by the claims, and all modifications or variants derived from the meaning and scope of the claims and their equivalents should be interpreted as being included within the scope of the present disclosure.

1. A binder composition for a negative electrode, comprising:
a block copolymer comprising structural units derived from an aromatic vinyl monomer and a conjugated diene monomer; and
water;
wherein the block copolymer is dispersed in the water in a liquid colloidal state.

2. The binder composition for a negative electrode of claim 1,
wherein the aromatic vinyl monomer comprises at least one selected from the group consisting of styrene, α-methylstyrene, vinyltoluene, t-butylstyrene, halogen-substituted styrene, 1,3-dimethylstyrene, 2,4-dimethylstyrene, and ethylstyrene.

3. The binder composition for a negative electrode of claim 1, wherein a content of the structural units derived from the aromatic vinyl monomer is 15 to 45 parts by weight based on 100 parts by weight of the block copolymer.

4. The binder composition for a negative electrode of claim 1,
wherein the conjugated diene monomer comprises at least one selected from the group consisting of 1,3-butadiene, isoprene, 2,3-dimethyl-1,3-butadiene, 2,3-dimethylbutadiene, 2-phenyl-1,3-butadiene, 2-chloro-1,3-butadiene, 1,3-pentadiene, 2-methyl-1,3-pentadiene, 3-methyl-1,3-pentadiene, 4-methyl-1,3-pentadiene, 1,3-hexadiene, 2-ethyl-1,3-butadiene, 2,4-hexadiene, and cyclo-1,3-hexadiene.

5. The binder composition for a negative electrode of claim 1,
wherein the block copolymer has a weight-average molecular weight of 50,000 to 150,000 g/mol.

6. The binder composition for a negative electrode of claim 1,
wherein at least a portion of polymer chains of the block copolymer is modified with at least one selected from a compound comprising silicon, a compound comprising nitrogen, a compound comprising sulfur, and a compound comprising oxygen.

7. The binder composition for a negative electrode of claim 1,
further comprising an emulsifier.

8. The binder composition for a negative electrode of claim 7,
further comprising a (meth)acrylate-based polymer,
wherein a weight ratio of the emulsifier to the (meth)acrylate-based polymer is 1:2.5 to 10.

9. The binder composition for a negative electrode of claim 1,
wherein a content of an organic solvent is less than 1 wt %.

10. The binder composition for a negative electrode of claim 1,
wherein the block copolymer is dispersed in the water in the form of particles having an average particle size of 50 to 1,000 nm.

11. A negative electrode slurry composition, comprising:
the binder composition for a negative electrode of claim 1; and
a negative electrode active material comprising a silicon-based compound.

12. The negative electrode slurry composition of claim 11,
wherein the negative electrode active material further comprises at least one selected from the group consisting of crystalline artificial graphite, crystalline natural graphite, amorphous hard carbon, low-crystallinity soft carbon, carbon black, acetylene black, Ketjen black, graphitized carbon fiber, aluminum, tin, lead, zinc, bismuth, indium, magnesium, gallium, cadmium, tin alloy, aluminum alloy, vanadium oxide, lithium vanadium oxide, silicon-carbon composite, and tin-carbon composite.

13. The negative electrode slurry composition of claim 12,
wherein a content of the silicon-based compound is 5 parts by weight or more based on 100 parts by weight of the negative electrode active material.

14. The negative electrode slurry composition of claim 11,
further comprising at least one conductive agent selected from the group consisting of natural graphite, artificial graphite, acetylene black, Ketjen black, furnace black, lamp black, thermal black, carbon nanotubes, carbon fiber, graphene, copper, aluminum, nickel, gold, silver, and conductive polymer.

15. A secondary battery comprising:
a positive electrode, a negative electrode, a separator interposed therebetween, and an electrolyte, or
an all-solid-state battery comprising a positive electrode, a negative electrode, and a solid electrolyte layer interposed therebetween,
wherein the negative electrode is prepared by coating the negative electrode slurry composition of claim 11 onto a current collector and then drying the same.
